(19) United States
(12) Patent Application Publication
(10) Pub. No.: US 2011/0301984 A1
(43) Pub. Date: Dec. 8, 2011

(54) SYSTEM AND METHOD FOR GENERATING A CUSTOMIZED PROPOSAL IN THE DEVELOPMENT OF INSURANCE PLANS

(76) Inventors: Jerome Dale Johnson, North Mankato, MN (US); Dale Arthur Mehr, Mankato, MN (US); Bryan Fisel, Janesville, MN (US)

(21) Appl. No.: 13/102,001

(22) Filed: May 5, 2011

Related U.S. Application Data
(62) Division of application No. 11/152,571, filed on Jun. 13, 2005, now abandoned.
Application No. 11/152,571 is a continuation of application No. 09/739,448, filed on Dec. 18, 2000.
(60) Provisional application No. 60/172,552, filed on Dec. 18, 1999.

(51) Int. Cl. G06Q 40/00

(52) U.S. Cl. 705/4

(57) ABSTRACT

A method for generating a customized proposal in the development of insurance plans for a customer is provided. Customer data is stored within a database in a computer system. This database has stored insurance plan products. A description of insurance plan options available to the customer is displayed on a display device based upon the stored customer data and user selected plan options obtained from an input device. A customized proposal is generated based upon a selection made from the presented insurance plan options. The customized proposal includes a description of an insurance plan, at least a portion of the customer data, and estimated costs for the insurance plan. In addition, a computer system and a computer program product readable by a computer system having computer-executable instructions that when executed cause a processor of a computer system to perform this method are provided.

### CROSS REFERENCE TO RELATED APPLICATIONS

The present divisional application claims the benefit of U.S. patent application Ser. No. 11/152,571, filed on Jun. 13, 2005, which is a continuation of U.S. patent application Ser. No. 09/739,448, filed Dec. 18, 2000, and entitled “System and Method for Providing Configuration and Sales Information to Assist in the Development of Insurance Plans”, which claims the benefit of U.S. Provisional Patent Application Ser. No. 60/172,552, filed Dec. 18, 1999, and entitled “System and Method for Providing Configuration and Sales Information to Assist in the Development of Insurance Plans” under 35 U.S.C. 119(e).

### FIELD OF THE INVENTION

This invention relates in general to a method and apparatus for assisting in providing configuration and sales information to salesperson and customers, and more particularly to a method and apparatus for assisting in providing configuration and sales information for the development of insurance plans.

### BACKGROUND OF THE INVENTION

The sales and configuration of employee insurance benefit plans represents a complex process that requires a combination of sales functions such as customer contact, proposal tracking, and cost/price information, as well as an insurance plan configuration function that ensures that a customer not only selects the plan that best fits their needs for a given costs but also configures a plan that may be provided given insurance plan related rules related to the combination of products. To be successful, a salesperson needs to have immediate access to all of the contact and status information needed to make a successful sale of a product. The salesperson must also be able to provide a customer with information regarding the available options for the insurance products that a customer may consider.

Because not all products are available or appropriate for all customers, the salesperson needs to be able to easily and quickly determine which of the available products would suit the individual customers needs. Finally, the salesperson needs to be able to easy transmit the necessary information to other insurance personnel, such as underwriters, in order for a sale to be finalized.

At the present time, no single product is available to satisfy all of the above needs of an insurance salesperson. As a result, the salesperson may need to interact with a multitude of different tools to do a single sales task. In addition, each of these tools needs to be separately maintained and updated. Because the tools are typically separately created, the data contained therein may not be correct or consistent across all of the needed tools. By combining all of these functions into a single automated system, a salesperson may use a single tool that addresses all of his or her needs. The single tool is more likely to be all maintained and updated at one time with any inconsistencies identified and eliminated before a salesperson begins interacting with a customer. Finally, by combining all of these tools into a single database, the salesperson may prepare and provide a complete proposal based upon all of the best information that is currently available which will ensure that the best configuration of insurance products will be made available to a customer given a particular set of needs and constraints.

### SUMMARY OF THE INVENTION

To overcome the limitations in the prior art described above, and to overcome other limitations that will become apparent upon reading and understanding the present specification, the present invention discloses a method, apparatus and article of manufacture for assisting in providing configuration and sales information to salesperson.

The present invention solves the above-described problems by providing a method and apparatus for assisting in providing configuration and sales information for the development of insurance plans.

A system in accordance with the principles of the present invention includes a computer assisted method for providing for assisting in providing configuration and sales information for the development of insurance plans for a customer. The method collects customer data within a sales computer system, stores the customer data within a database on the sales computer system, and presents a description of the insurance plan options available based upon the customer data. Based upon this presented data, the customer or salesperson selects a preferred set of insurance plans from the available insurance plan options and determining an estimated cost for the preferred set of insurance plans; and generates a customized proposal for the preferred set of insurance plans, including the customer data, the description of the preferred insurance plans, and the estimated costs for the preferred set of insurance plans.

Other embodiments of a system in accordance with the principles of the invention may include alternative or optional additional aspects. One such aspect of the present invention is that a computer data signal embodied in a carrier wave readable by a computing system and encoding a set of computer instructions for providing customers, and more particularly salesperson, a method and apparatus for Resisting in providing configuration and sales information for the development of insurance plans.

Another such aspect is a computer-readable medium having stored thereon a data structure a set of computer instructions for providing customers, and more particularly salesperson, a method and apparatus for assisting in providing configuration and sales information for the development of insurance plans.

Yet another such aspect is a system for providing customers, and more particularly salesperson, a method and apparatus for assisting in providing configuration and sales information for the development of insurance plan& This insurance sales and configuration system for providing a system to assist in providing configuration and sales information for the development of insurance plans to a customer. The system includes a transportable sales computing system having a customer data input module for accepting customer data, a sales tool module, an insurance plan database, a plan configuration engine module, and a proposal generator module. The system also includes a communication connection to a server computing system for providing application data from the customer and for receiving status and database updates and an information and proposal output module for providing insurance information to the customer.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### DESCRIPTION OF THE DRAWINGS

Referring now to the drawings in which like reference numbers represent corresponding parts throughout:

FIG. 1 illustrates a one possible organization for a distributed computing system for providing customers, and more particularly salesperson, a method and apparatus for assisting in providing configuration and sales information for the development of insurance plans utilizing one possible embodiment of the present invention.

FIG. 2 illustrates a interconnection of functional modules for providing customers, and more particularly salesperson, a method and apparatus for assisting in providing configuration and sales information for the development of insurance plans according to an exemplary embodiment of the present invention.

FIG. 3 illustrates a computing system that may be used as the sales computing system according to one embodiment of the present invention.

FIG. 4 illustrates an insurance configuration and sales system according to another possible embodiment of the present invention.

FIG. 5 illustrates a solutions module within an insurance configuration and sales computing system according to yet another possible embodiment of the present invention.

FIG. 6 illustrates a group module within an insurance configuration and sales computing system according to an example embodiment of the present invention.

FIG. 7 illustrates a benefits design module within an insurance configuration and sales computing system according to the present invention.

FIG. 8 illustrates a proposal module within an insurance configuration and sales computing system according to one possible embodiment of the present invention.

FIG. 9 illustrates a status module within an insurance configuration and sales computing system according to one possible embodiment of the present invention.

FIG. 10 illustrates a library module within an insurance configuration and sales computing system according to another possible embodiment of the present invention.

FIG. 11 (which is made up of FIGS. 11A-11H) illustrates an example proposal generated by an insurance configuration and sales computing system according to the present invention.

### DETAILED DESCRIPTION

Embodiments of the present invention provide a method and apparatus for assisting in providing configuration and sales information to salesperson and customers, and more particularly to a method and apparatus for assisting in providing configuration and sales information for the development of insurance plans.

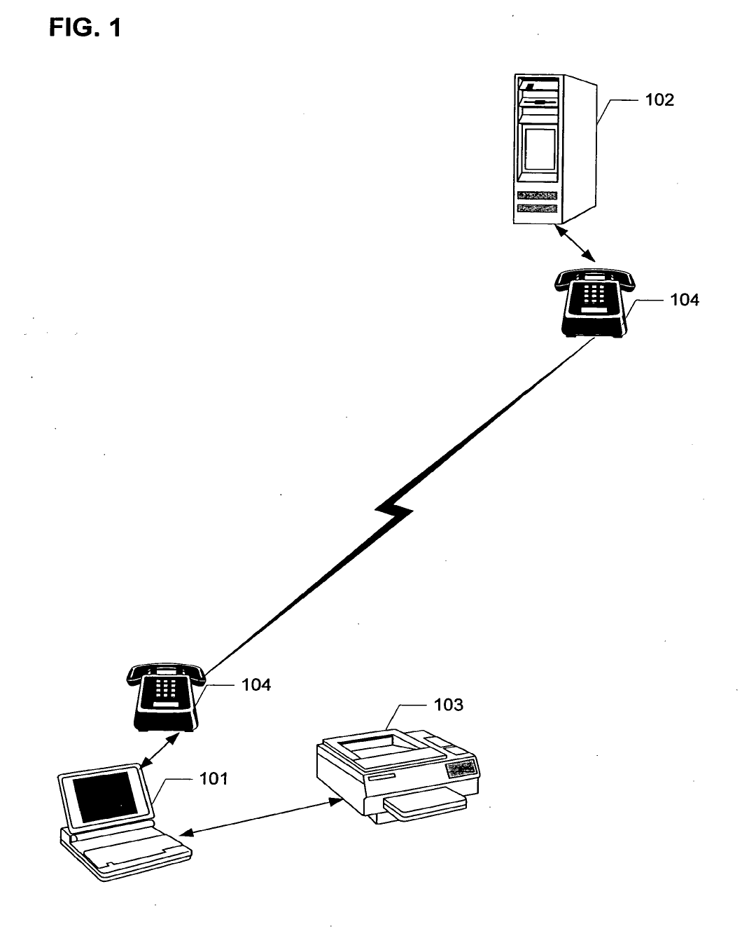

FIG. 1 illustrates a one possible organization for a distributed computing system for providing customers, and more particularly salesperson, a method and apparatus for assisting in providing configuration and sales information for the development of insurance plans utilizing one possible embodiment of the present invention. Typically, a salesperson visits a customer at the customer's office with a portable computer 101 that may interface to a printer 103. Back at the salesperson's office, a server computer 102 is maintained to provide customer information to non-sales personnel such as underwriting. The salesperson's computer 101 and the server computer 102 may communicate this data with each other over ordinary telephone lines 104. Of course, this communication may also occur over other communications means such as the internet. The salesperson will collect all of the customer's relevant data for use by the server computer 102.

At the same time, the salesperson attempts to inform the customer of all of the available products. This information may be in the form of oral descriptions, printed documents, audio-visual presentations, and the like. These materials may be stored electronically upon the sales computer 101 and displayed for the customer, printed for the customer's review, and provided in electronic form. Because only some of this voluminous information is needed by a given customer, an automated mechanism to sort through this material is useful.

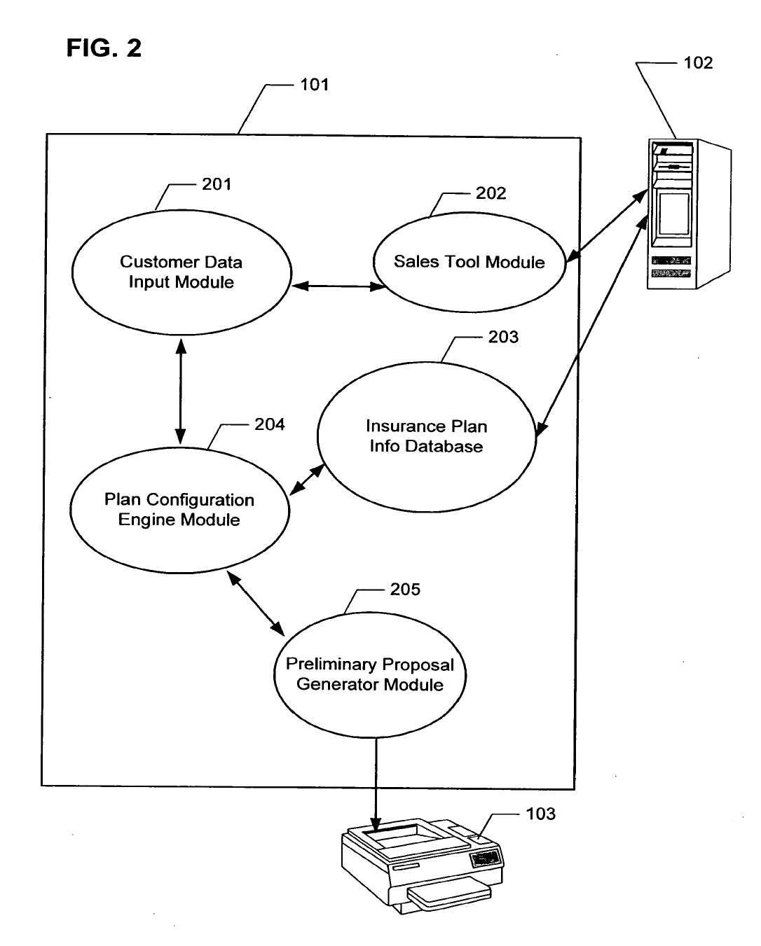

FIG. 2 illustrates a interconnection of functional modules for providing customers, and more particularly salesperson, a method and apparatus for assisting in providing configuration and sales information for the development of insurance plans according to an exemplary embodiment of the present invention.

The insurance configuration and sales system is a consolidated, multimedia application that delivers configuration, pricing, quoting, proposal generation, financial analysis, and marketing encyclopedia functionality. In its initial embodiment, the insurance configuration and sales system provides agents and agencies the ability to produce preliminary quotes (i.e. street rate quotes) for small group products. In addition, the system provides an ability to track the status of proposals, store and print sales collateral material and forms, and demonstrate a product discovery consultation function.

The insurance configuration and sales system is a component based, object oriented design that is distributed across a multi-tier architecture. This architecture consists of an Application Layer, a Presentation Layer, a Session Layer, and a Data Layer. This implementation is a stand-alone version of the application, which is configured as a “fat client” with all four layers residing on the client. The Web version of this application (Signature Plus Web 2.5) is configured as a “thin client” with only the Application Layer residing on the client. The other three layers reside on a Web server.

An architecture for the stand-alone embodiment of the insurance configuration and sales system is illustrated here. The user interfaces with the application through the Application Layer. This layer consists of a Visual Basic form and a browser (i.e. Microsoft's Internet Explorer) ActiveX Control. The Visual Basic form wraps the browser ActiveX Control and acts as a container for the entire user interface. This design allows the container to be tailored to the specific requirements a insurance configuration and sales system while reusing the browser ActiveX Control. The Visual Basic form provides common state management and services to all components within the system while the ActiveX Control provides the window for displaying information.

A user interface provided by the Application Layer is driven by Hypertext Markup Language (HTML) generated by the Presentation Layer. The Presentation Layer facilitates interaction between the user and the underlying business objects contained in the Session Layer. The Presentation Layer consists of a Transformer and ActiveX Script component. The Transformer handles communication with the browser whereas ActiveX Script technology is used to communicate with the various business objects. Business objects present information to the user by generating HTML pages via the Presentation Layer for display in the browser window. Events generated by the user in the browser window are conveyed to the appropriate business objects via the Transformer and ActiveX Scripts contained in the Presentation Layer.

The insurance configuration and sales system functionality is defined by the set of business objects contained in the Session Layer. These business objects are tailored to meeting the needs of a specific business process. Each business object responds to user generated events to provide specific functionality. Each business object in turn interacts with the semantic data models contained in the Data Layer. Business objects are grouped, based on the functionality they provide, into a single unit called a “module.”

Referring to FIG. 2, the sales computing system 101 includes a customer data input module 201, a sales tool module 202, an insurance plan info database 203, a plan configuration engine module 204, and a preliminary proposal generator module 205. The customer data input module 201 allows the salesperson to enter all of the relevant information into the sales computing system 101. Once this data in input into the system 101, the data may be used by all other modules. This data may include customer contact information for use by the salesperson as a sales aid as well as employee census data that is needed to configure the insurance products. The significant point is that this data is input only once into the system and is forever available for use by all modules. Since all of the modules are using this data, accurate estimates of cost and plan availability may be made as long as this data is accurate.

The sales tool module 202 includes the customer contact and proposal status information needed by a sales person to make a sale. This information is a customer contact database that includes active and updated status information on the ongoing proposals. The modules use the same information input by the customer data input module 201 this ensuring the salesperson has the current information at all times. This module may interface with the server computer 102 to maintain the current information accurately.

The insurance plan info database 203 is a database of the products currently being offered for sale. The database will have descriptions of the products, related costs information, and plan requirements data. This database is used by the other components of the system to, perform their functions of a single set of common product data

The plan configuration engine module 204 uses the customer's selections along with the insurance plan info database 203 to construct a set of insurance plans for consideration by the customer. This module 204 uses the plan requirements data along with the customer's own census data to ensure that the plan configured by the salesperson for the customer is a plan that may ultimately be sold to this particular customer.

The preliminary proposal generator module 205 takes the plan produced by the plan configuration engine module 204 along with cost data to prepare a formal proposal to the customer. This proposal may be in the form of a wad processing document that may be saved and edited. It may also contain personalized graphics data to uniquely identify the source of the proposal as well as the customer to whom it is being offered.

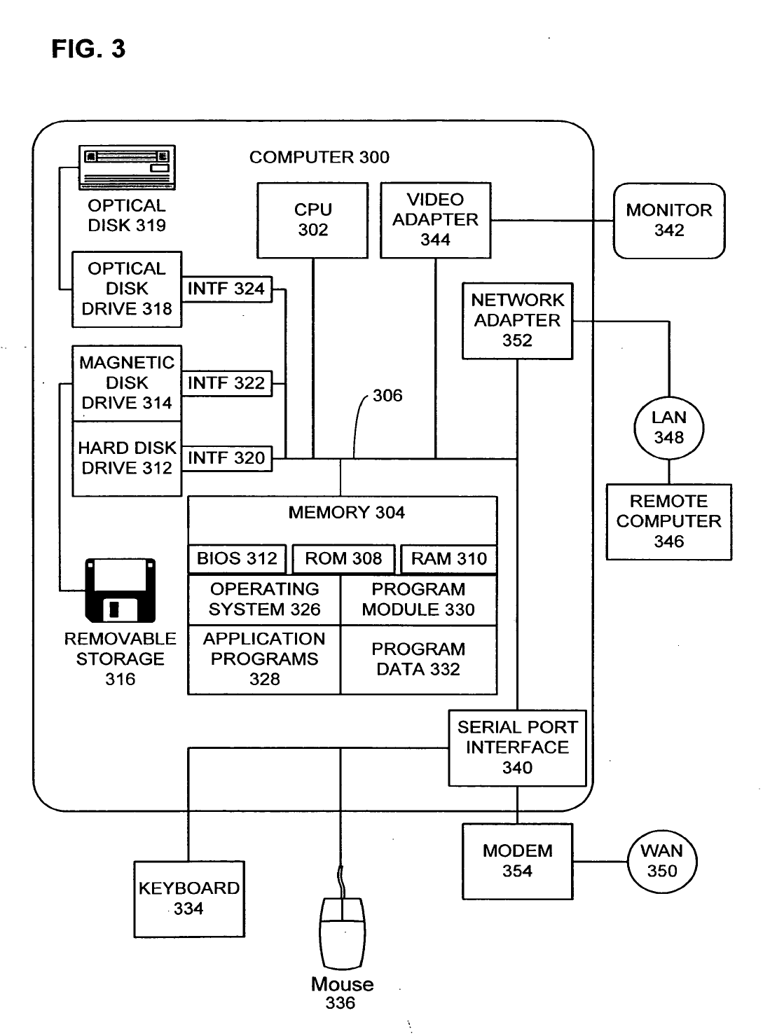

FIG. 3 illustrates a computing system that may be used as the sales computing system according to one embodiment of the present invention. An exemplary computing system for embodiments of the invention includes a general purpose computing device in the form of a conventional computer system 300, including a processor unit 302, a system memory 304, and a system bus 306 that couples various system components including the system memory 304 to the processor unit 300. The system bust.dagger.306 may be any of several types of bus structures including a memory bus or memory controller, a peripheral bus and a local bus using any of a variety of bus architectures. The system memory includes read only memory (ROM) 308 and random access memory (RAM).dagger.310. A basic input/output system 312 (BIOS), which contains basic routines that help transfer information between elements within the computer system 300, is stored in ROM 308.

The computer system 300 further includes a hard disk drive 312 for reading from and writing to a hard disk, a magnetic disk drive 314 for reading from or writing to a removable magnetic disk 316, and an optical disk drive 318 for reading from or writing to a removable optical disk 319 such as a CD ROM, DVD, or other optical media. The hard disk drive 312, magnetic disk drive 314, and optical disk drive 318 are connected to the system bus 306 by a hard disk drive interface 320, a magnetic disk drive interface 322, and an optical drive interface.dagger.324, respectively. The drives and their associated computer-readable media provide nonvolatile storage of computer readable instructions, data structures, programs, and other data for the computer system 300.

Although the exemplary environment described herein employs a hard disk, a removable magnetic disk 316, and a removable optical disk 319, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk, magnetic disk 316, optical disk 319, ROM 308 or RAM 310, including an operating system 326, one or more application programs 328, other program modules 330, and program data 332. A user may enter commands and information into the computer system 300 through input devices such as a keyboard 334 and mouse 336 or other pointing device. These and other input devices are often connected to the processing unit 302 through a serial port interface 340 that is coupled to the system bus.dagger.306. Nevertheless, these input devices also may be connected by other interfaces, such as a parallel port, game port, or a universal serial bus (USB). A monitor 342 or other type of display device is also connected to the system bus 306 via an interface, such as a video adapter.dagger.344. In addition to the monitor 342, computer systems typically include other peripheral output devices (not shown), such as speakers and printers.

The computer system 300 operates in a networked environment as in FIG. 2 using logical connections to one or more remote computers, such as a remote computer 346. The network connections include a local area network (LAN) 348 and a wide area network (WAN) 350. Such networking environments are commonplace in offices, enterprise-wide computer networks, intranets, and the Internet.

When used in a LAN networking environment, the computer system 300 is connected to the local network 348 through a network interface or adapter 352. When used in a WAN networking environment, the computer system 300 typically includes a modem 354 or other means for establishing communications over the wide area network 350, such as the Internet. The modem 354, which may be internal or external, is connected to the system bus 306 via the serial port interface 340. In a networked environment, program modules depicted relative to the computer system 300, or portions thereof, may be stored in the remote memory storage device. It will be appreciated that the network connections shown are exemplary, and other means of establishing a communications link between the computers may be used.

The embodiments of the invention described herein are implemented as logical operations in a telecommunications system having connections to a distributed network such as the Internet. The logical operations are implemented (1) as a sequence of computer implemented steps running on a computer system and (2) as interconnected machine modules running within the computing system. The implementation is a matter of choice dependent on the performance requirements of the computing system implementing the invention. Accordingly, the logical operations making up the embodiments of the invention described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto.

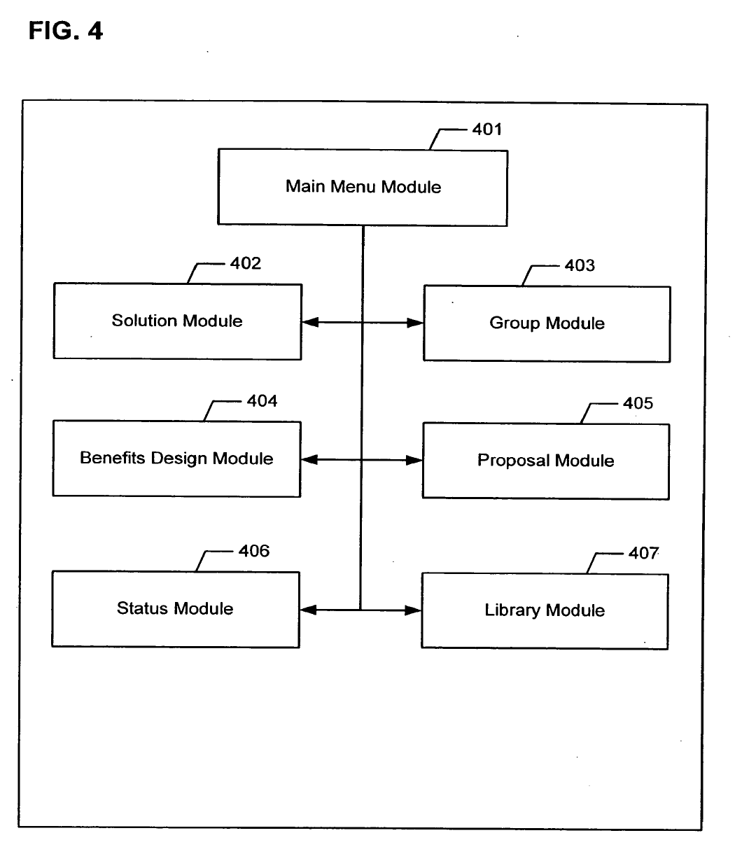

FIG. 4 illustrates an insurance configuration and sales system according to another possible embodiment of the present invention. The system has a user interface that begins with a main menu module 401 which permits the user to select each of the other modules which are to be used in the configuration and sale of insurance products to customers. The remaining modules with in the system include a solution module 402, a group module 403, a benefits design module 404, a proposal module 405, a status module 406, and a library module 407. Bach of these modules are described in detail below. The modules work together as a complete system to provide a method and apparatus for assisting in providing configuration and sales information for the development of insurance plan.

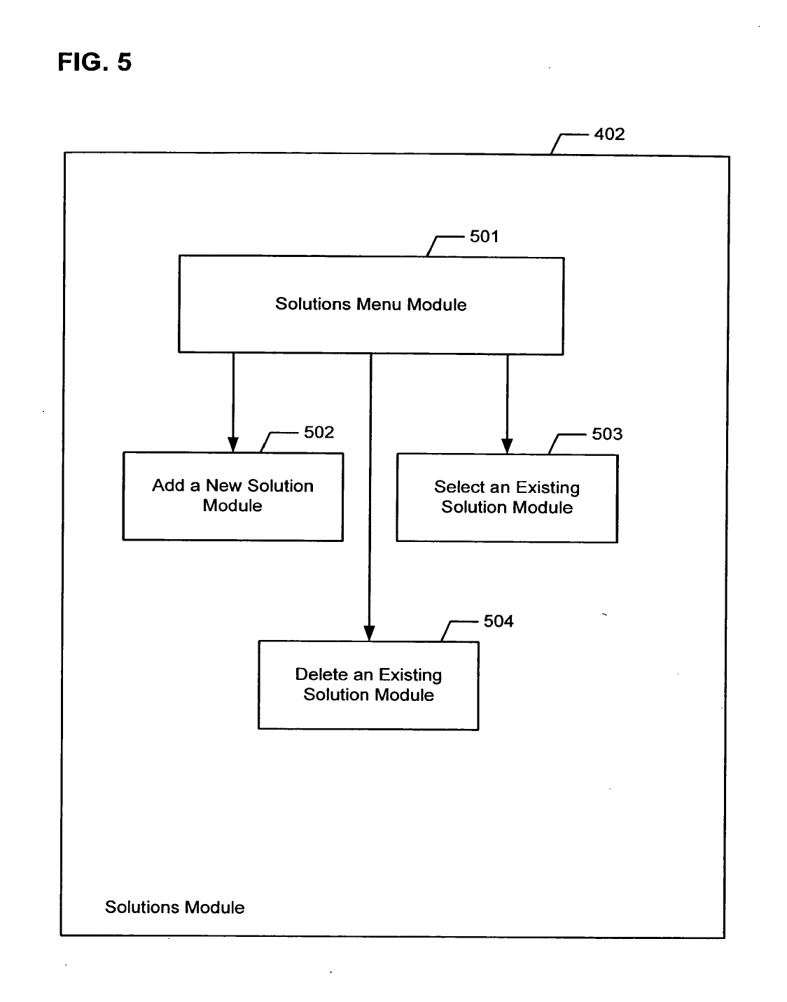

FIG. 5 illustrates a solutions module within an insurance configuration and sales computing system according to yet another possible embodiment of the present invention. In one embodiment of a present invention, a “solution” is viewed as one possible plan selection that may be sold to a particular customer. Using this construct, the system uses the solution as the basic entity for a sale that needs to be created, stored, retrieved, viewed, modified and deleted. The solutions module 402 includes a solutions menu module 501 that presents a user with the ability to manipulate these solutions are part of his or her interaction with various customers. The user uses a set of modules to create a new solution using an Add a New Solution Module 502. The user uses these modules to retrieve a stored solution using an Select a Solution Module 503. The user also uses these modules to delete a saved solution using a Delete a Solution Module 504. At times during the other processing within the system, a currently selected or created solution is saved for later retrieval.

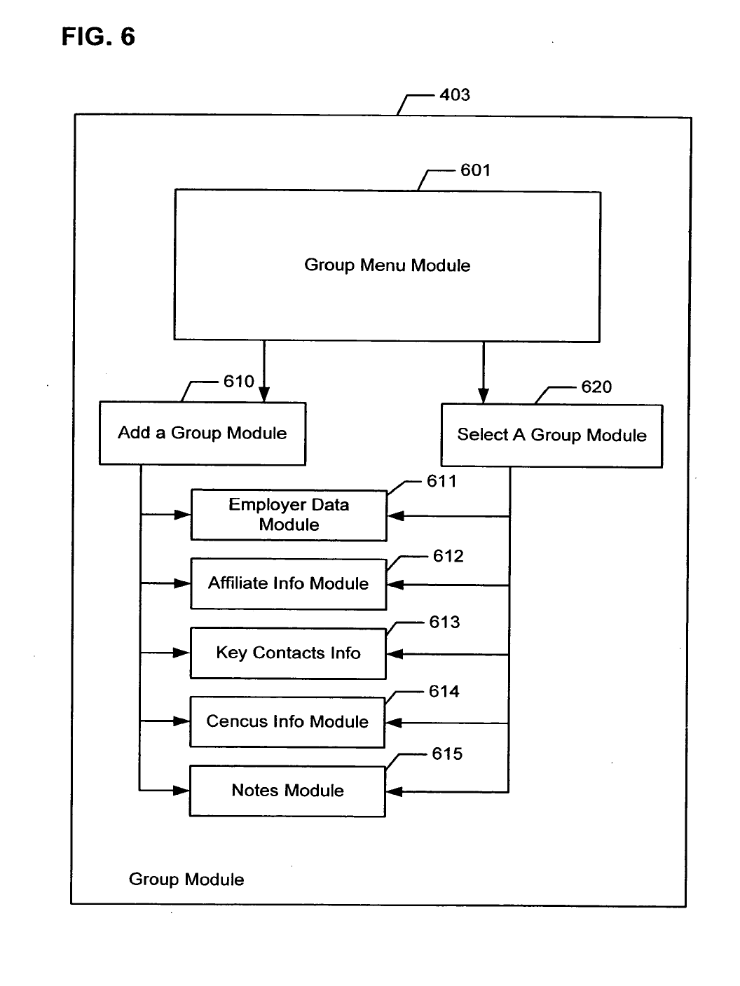

FIG. 6 illustrates a group module within an insurance configuration and sales computing system according to an example embodiment of the present invention. The Group Module allows insurance configuration and sales system user to manage group information. This includes adding new group information using an Add a New Group module 610 and editing existing group information using a Select a Group module 620. An existing group, once retrieved using the Select a Group module 620 may be edited using the same modules used to create the group and store the group data These modules include an Employer Data Module 611 for entering information about the employer/customer. These modules also include an include an Affiliate Data Module 612 for entering information about the related companies for this employer/customer. These modules include A Key Contacts Info Module 613 for entering contact information for persons the salesperson will interact during the sales process with the employer/customer. These modules further include a Census Info Module 614 for entering employee information about the employees to be covered by the selected plans. This census info should include all of the information needed to underwrite the insurance and process any application so that the data is entered into a system only once. Finally, these modules include a Notes Module 615 for entering information about the sales person's contacts with the employer/customer.

The insurance configuration and sales system users may add a new group. The Add a New Group dialog box allows the user to enter and keep track of information about the group. This information can be organized and stored so that changes can be made overtime, as they become necessary. The top of the dialog box contains a summary of group information. The bottom half of the dialog box contains four tabs that organize the information: General, Addresses, Contacts, and Census.

After the user has added group information, the Group module allows the user to edit group information. The insurance configuration and sales system users may select Edit Group Information from the Group module. This displays the Edit Group Information dialog box for the group whose information was summarized on the Group module screen. The top of the dialog box contains a summary of the group information. The bottom half of the dialog box contains four tabs that organize the information: General, Addresses, Phones, and Contacts.

The Group module allows the user to select an existing group. The insurance configuration and sales system users may choose Select an Existing Group from the Group module. This displays the Select an Existing Group dialog box, which consists of two parts: the top half of the screen, which displays summary information on the selected group, and the bottom half of the screen, which displays the Group's grid.

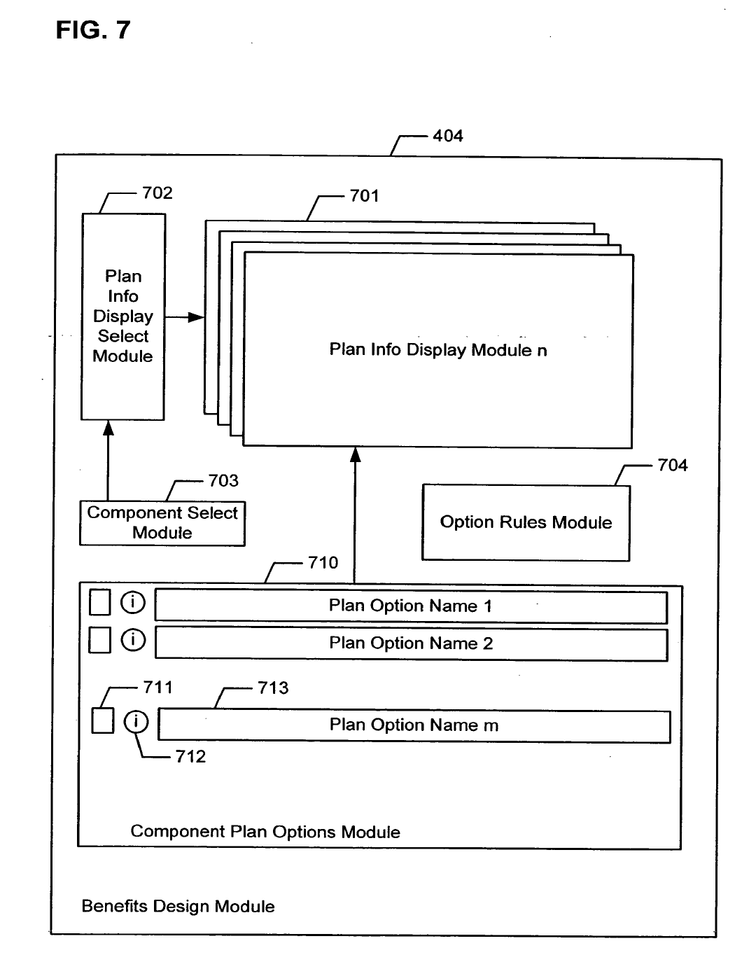

FIG. 7 illustrates a benefits design module within an insurance configuration and sales computing system according to the present invention. Using the Benefits Design Module 404, the user can select a plan. The configuration rules for the various plans are set up in a ConfigPlus Data Modeler and a ConfigPlus Data Editor tools within an Options Rules Module 704.

In one embodiment, a user can select a type of plan, whether it is Health, Life, STD or Dental. The top portion is an HTML page containing information about each Health Plan and the bottom part of the screen contains the actual plans that are being configured. This information corresponds to the one or more Plan info display modules 701.

This function allows the user to first select a plan by clicking on the plans in the bottom portion of the screen. Once they click on OK, they are taken to a second screen where the user can add, delete or modify Street Quotes to compare against different plans. Each Street Quote can only have one Health Plan, one Dental Plan, one Life Plan and one STD plan. In this screen the user is also given the ability to add a custom Plan, get access to the group module and show a cost per employee breakdown.

The system can be built to recommend a health plan based on the requirements entered by the user. This function would allow the user to select a particular type of plan based on soft requirements. The top portion of the HTML page would contain the user requirements. The bottom portion of the HTML page would contain the plans and these get evaluated based on the requirements entered by the user in the top page. The plan with the best match based on the user requirements would “bubble” to the top of the grid.

The options rules module 704 controls the interaction of the various modules within the Benefits Design Module 404. This module 704 also includes a Toolbox sets parameters that control or affect the access or the operation of modules in the insurance configuration and sales computing system.

The Toolbox General Information section allows the entry of company-specific information such as company name, address and phone number. The Toolbox General Information section also allows a user to set up and maintain users' names and passwords.

Local information about insurance configuration and sales computing system user appears in the printed output of the Proposal Module. Local information includes demographic and other information about the company and about users.

This function allows the user to enter the company name, address and phone numbers. Multiple addresses and phone numbers can be stored. Only one of each can be selected at any given time for a Signature Plus presentation. Each user (typically salespeople) can have a unique User Name and Password when using the insurance configuration and sales computing system. Access is also granted based on the user's role. Only people with a user name and password have access to the insurance configuration and sales computing system. In addition, proposals are personalized with the user's name. The roles are set in the Toolkit.

The Data Layer is supported by a relational database that supports two different types of database structures: product configuration specific and other. Access to these data structures is through an ADO/ODBC module, and a Configuration Knowledge Run-Time Module. ADO/ODBC module can be used to access data that is not product configuration specific and CKRT is used to access the data that is product configuration specific. The Signature Plus Toolkit is used to configure these database structures.

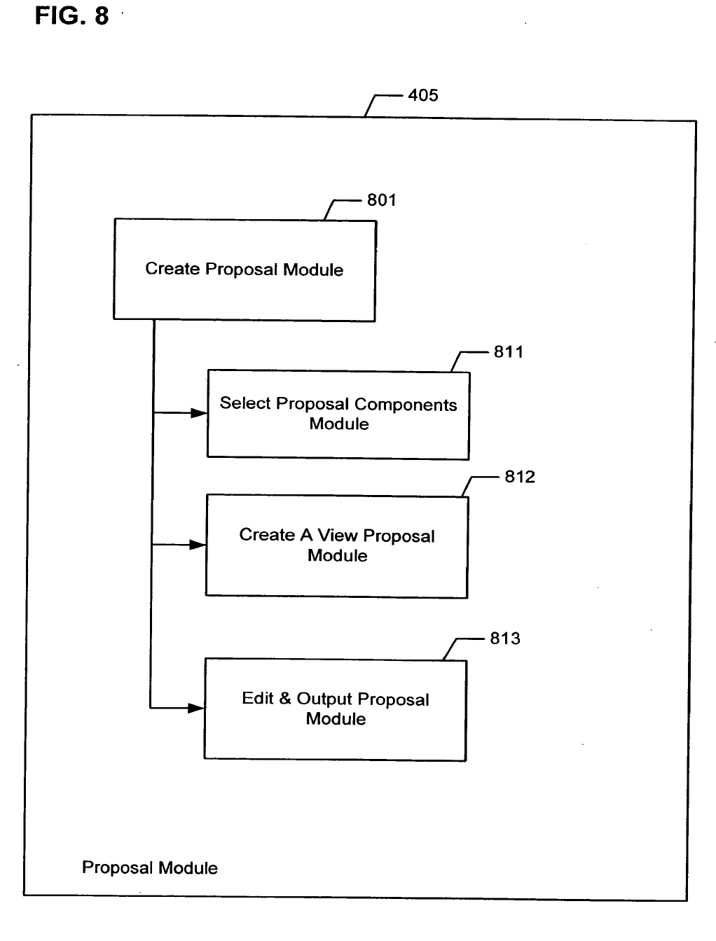

FIG. 8 illustrates a proposal module within an insurance configuration and sales computing system according to one possible embodiment of the present invention. The Proposal Module allows the user to print all of the information presented to a group during the users' session. This information is organized according to reports that are generated by each module. Reports are Microsoft Word templates (*.dot or *.rtf files) that have been set up to accept data from the database. The templates and the scripts used to pass data are managed in the Proposal Explorer tool.

The insurance configuration and sales computing system user can select from a pre-defined list of reports to create a complete proposal for the group in the . Select Proposal Components Module 811. Reports may not be available if the user did not visit the related module. This function allows the user to select reports for printing or previewing.

In the Proposal module, clicking the Create a New Proposal link launches the Create a New Proposal module 812. The list of available reports appears in the left windowpane in a tree format, organized by module.

Reports are available for each module for which enough information was entered or generated to complete the report. Reports are selected from the Available Reports list in the left window pane and added to the Selected Reports list in the right window pane. This feature allows the user to edit an existing proposal.

The Edit Proposal module 813 uses the same functions as the New Proposal feature (described above) and allows modifications to proposals previously created using the New Proposal feature. It is possible to password protect access to the edit proposal feature using the Proposal Explorer tool. The password is the salesperson's password.

This feature allows the user to print reports that have been selected for printing. Using the New Proposal or Edit Proposal features, the user selects the reports that will be printed by the Proposal module. These reports appear under Selected Reports in the right windowpane of the Proposal module screen Any printers installed for the Windows operating system are compatible with insurance configuration and sales computing system print engine.

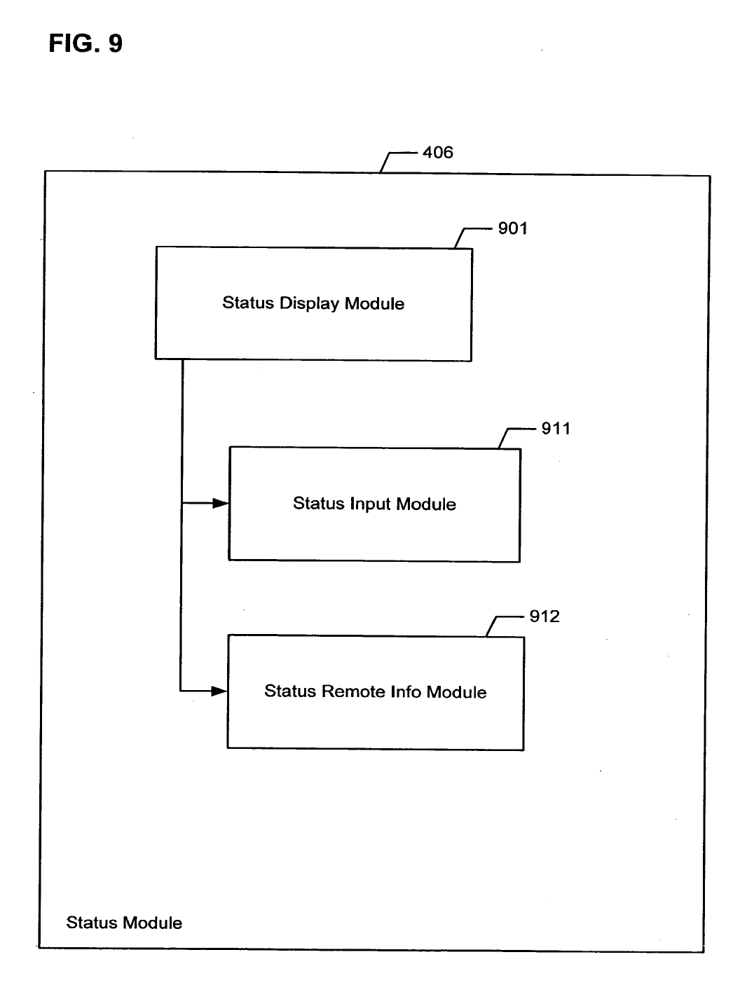

FIG. 9 illustrates a status module within an insurance configuration and sales computing system according to one possible embodiment of the present invention. Using the Status Module, the user can find out the status of the Quotes that have been submitted to the server system 102. The status module 406 has a status display module 901 to permit user to retrieve and review the available status information. This module 901 may communicate with the remote server system 102 to obtain information not found locally on the sales computing system 101.

The status module 406 also has a status input module 911 to permit user to add new information to the available status information and has a status remote info module 912 to permit user to retrieve and update the available status information.

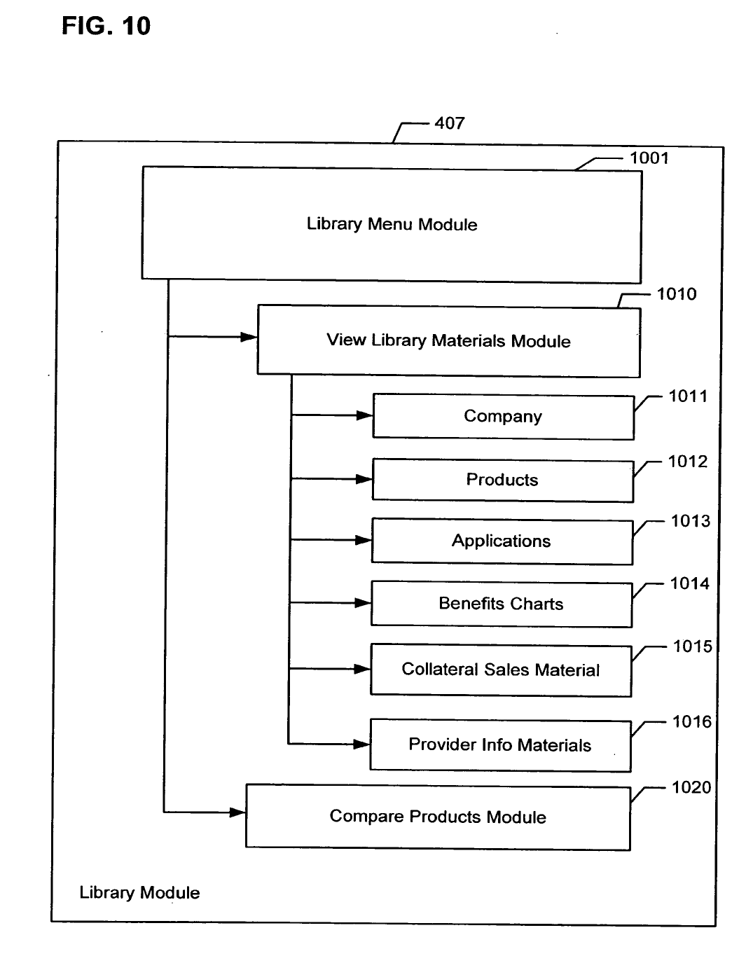

FIG. 10 illustrates a library module within an insurance configuration and sales computing system according to another possible embodiment of the present invention. The library module 407 presents users with a set of selections using a library menu module 1001. In the menu module 1001, the user selects either the view library materials module 1010 or the compare products module 1020. The view library materials module 1010 provides its own menu of selections which include Company Data Module 1011, Products Data Module 1012, Application Forms Module 1013, Benefit Charts Module 1014, Collateral Sales Material Module 1015, and Provider Info Material Module 1016. Each of these modules provides customers and sales personnel with documentation which is typically given to customers to act as reference materials about the insurance plans being considered.

The Company Data Module 1011 includes documentation regarding the insurance company providing the products. The Products Data Module 1012 includes detailed documentation regarding the insurance plans available from the salesperson. The Application Forms Module 1013 includes a set of electronic forms which pay be filled out on the computer or printed and completed to purchase the insurance plans offered to a customer. The Benefit Charts Module 1014 includes a subset of the Products Data Module 1012 that provides a set of charts summarizing all of the insurance plans in a common format to permit an easy comparison of benefits provided by each plan. The Collateral Sales Material Module 1015 includes other sales material useful in the sale of insurance products to customers. For example, the Collateral Sales Material Module 1015 may determine if an offered plan is available to the customer based upon other plans selected as part of the preferred set of insurance plans and/or the customer data. As such the other sales material may include an indication that another plan may be offered but is not currently available to the customer based upon other plans selected as part of the preferred set of insurance plans and/or the customer data. In addition, the other sales material may include an indication of what conditions are not met for the customer to qualify for the offered but currently not available insurance plan. The Provider Info Material Module 1016 includes documentation of the health care provides who are included within each plan. These documentation materials are typically stored in a common electronic format which will permit easy dissemination of the information. In the preferred embodiment, these materials are provided in an ADOBE .PDF format that is readily available on a wide variety of computing systems. As such, the salesperson may make these electronic file available to customers for review and printing. Other data may be presented in HTML and related graphic and audio-visual formats that are viewable on web based platforms.

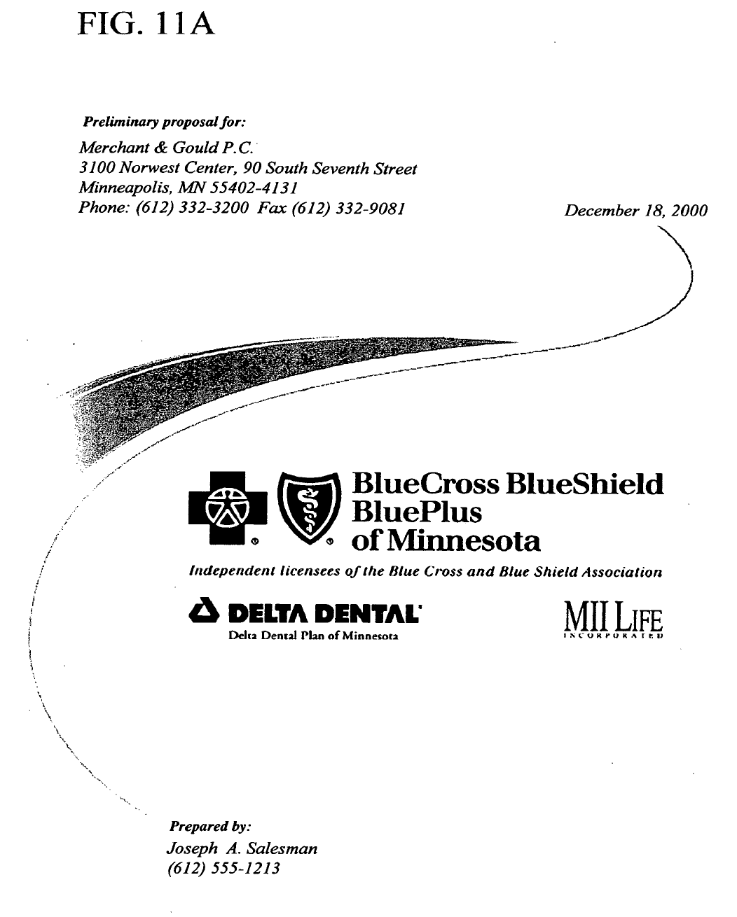

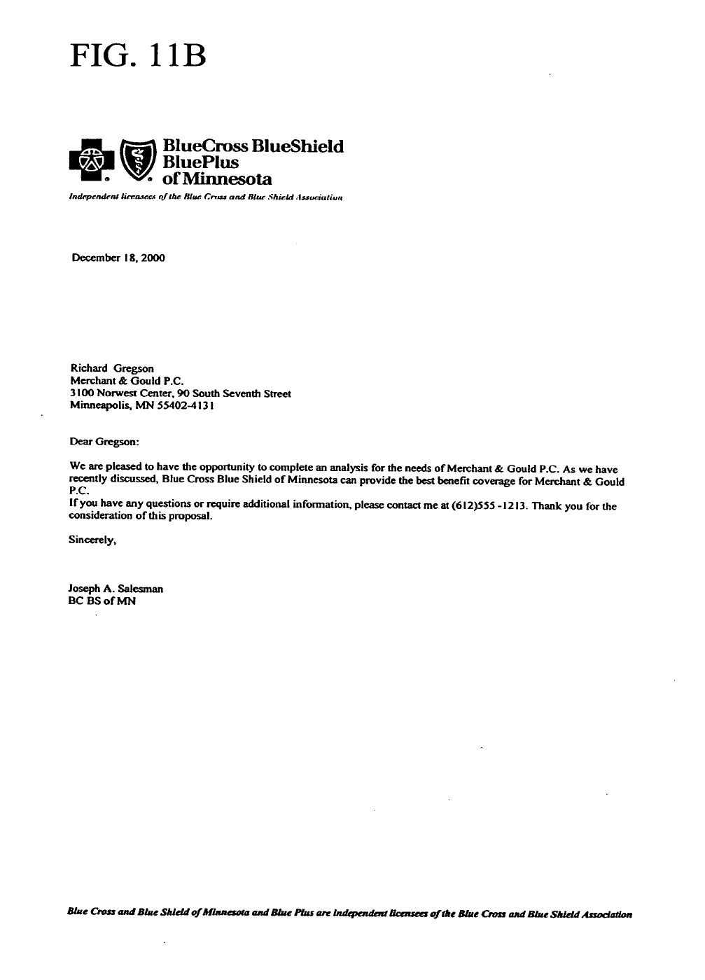

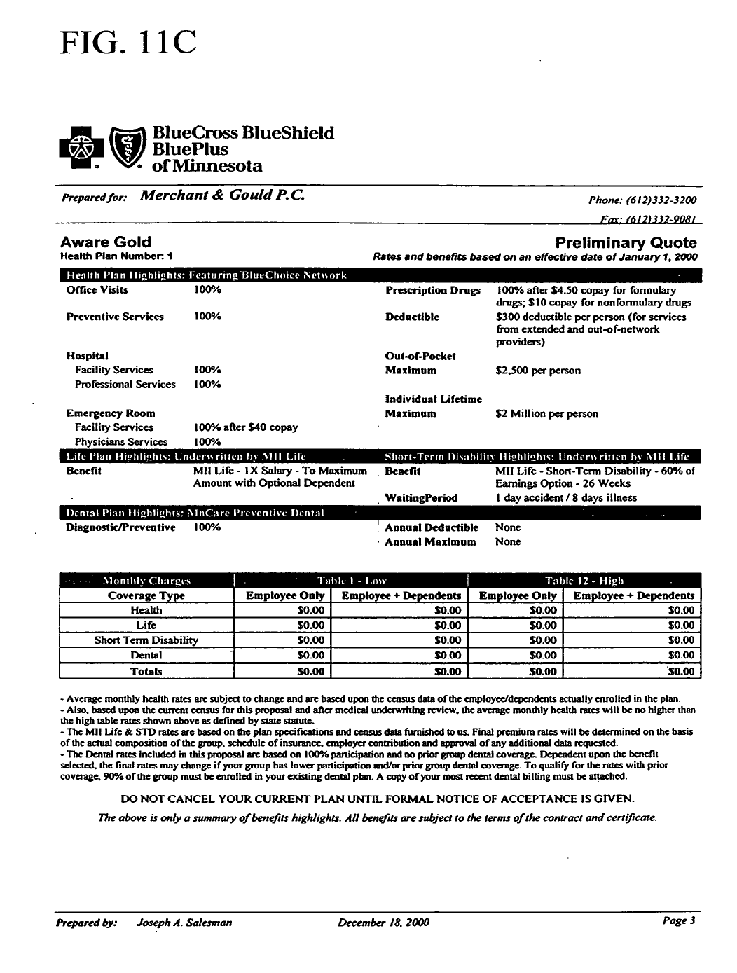

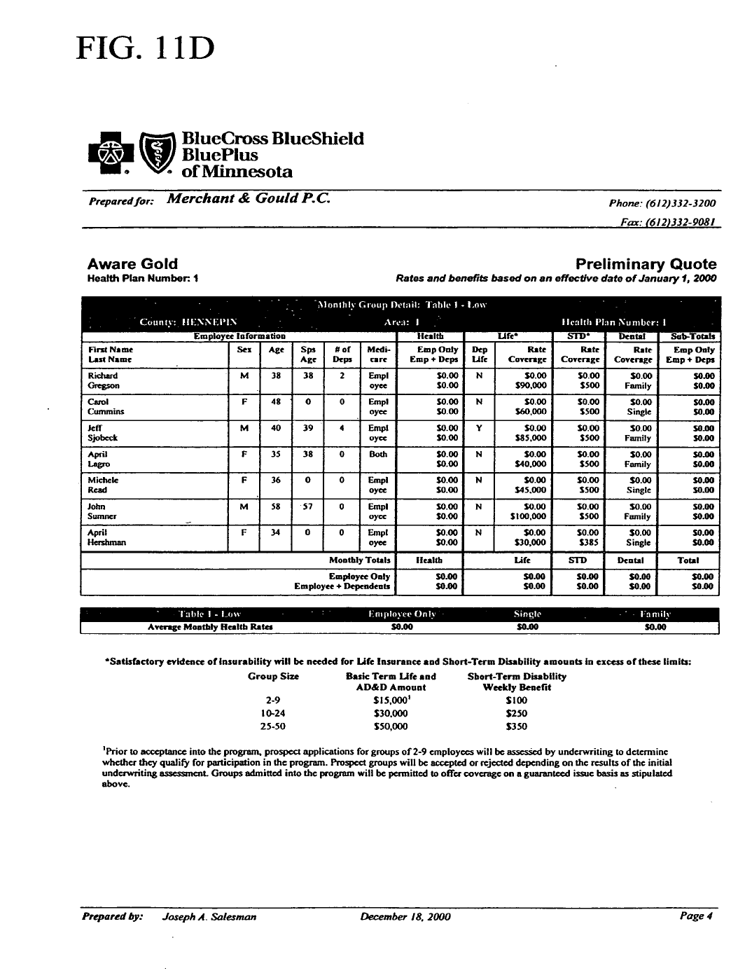

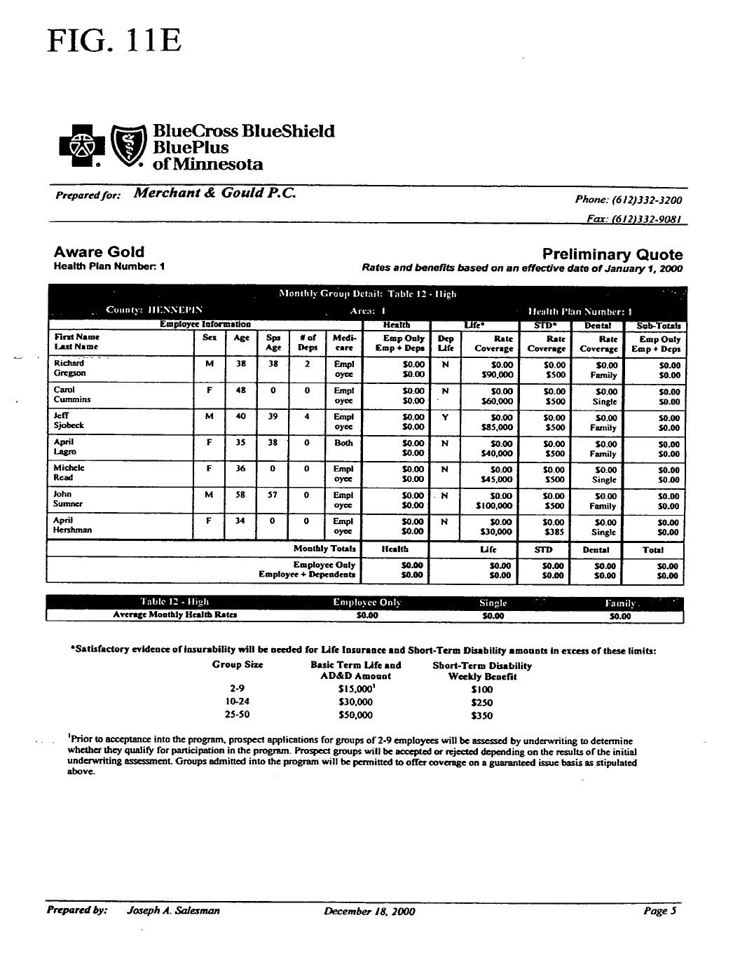

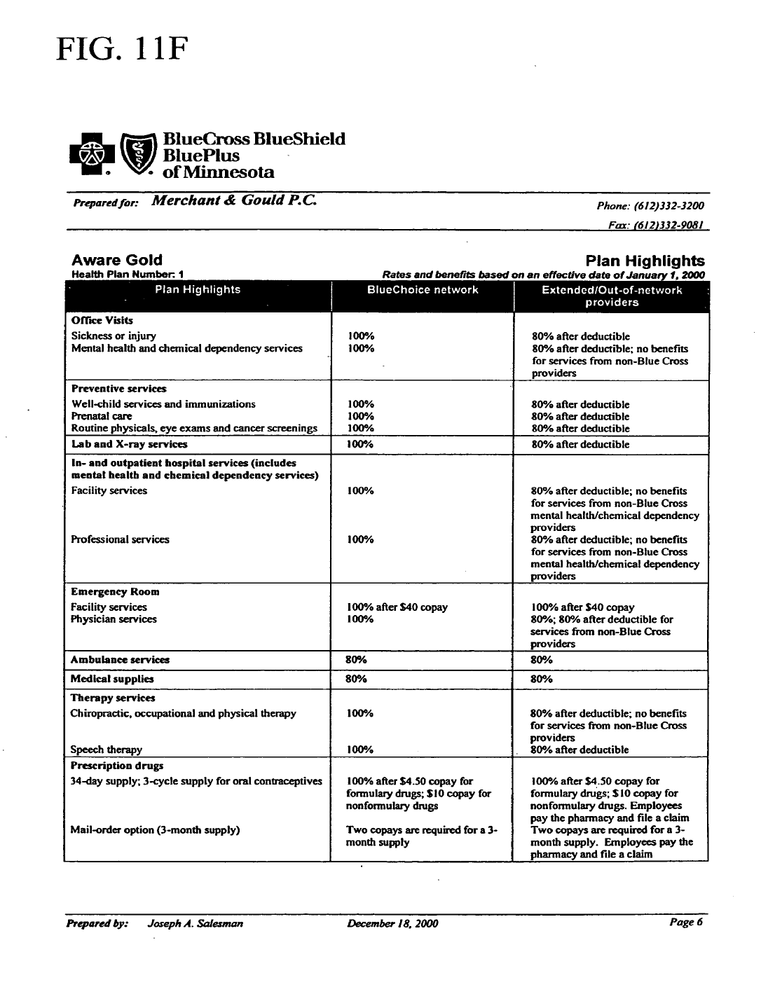

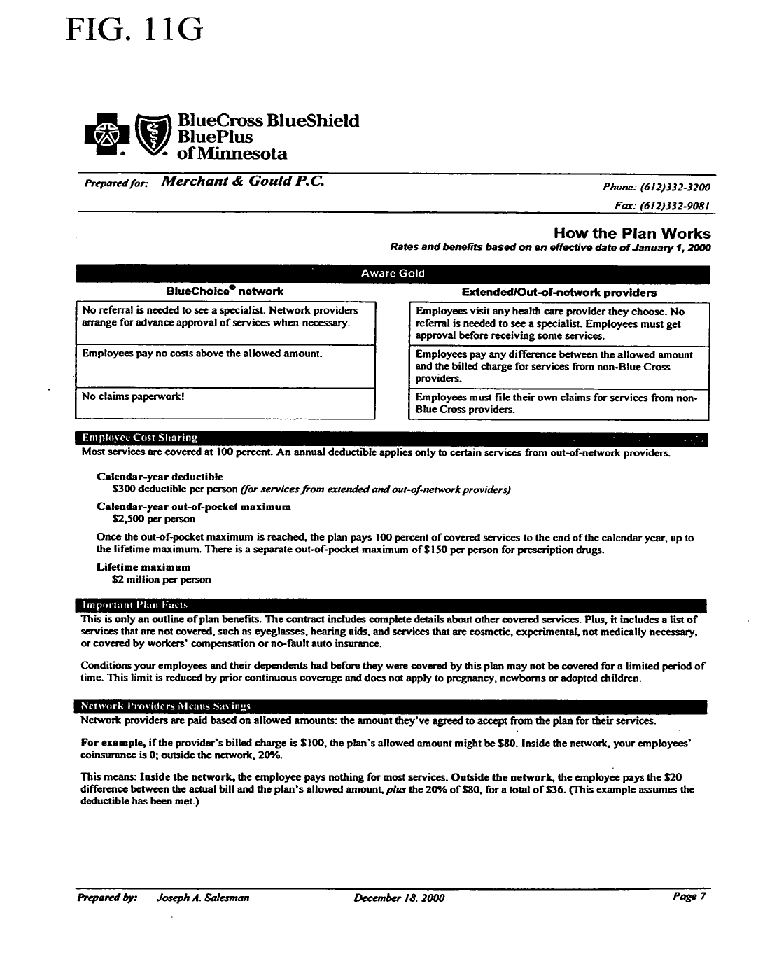

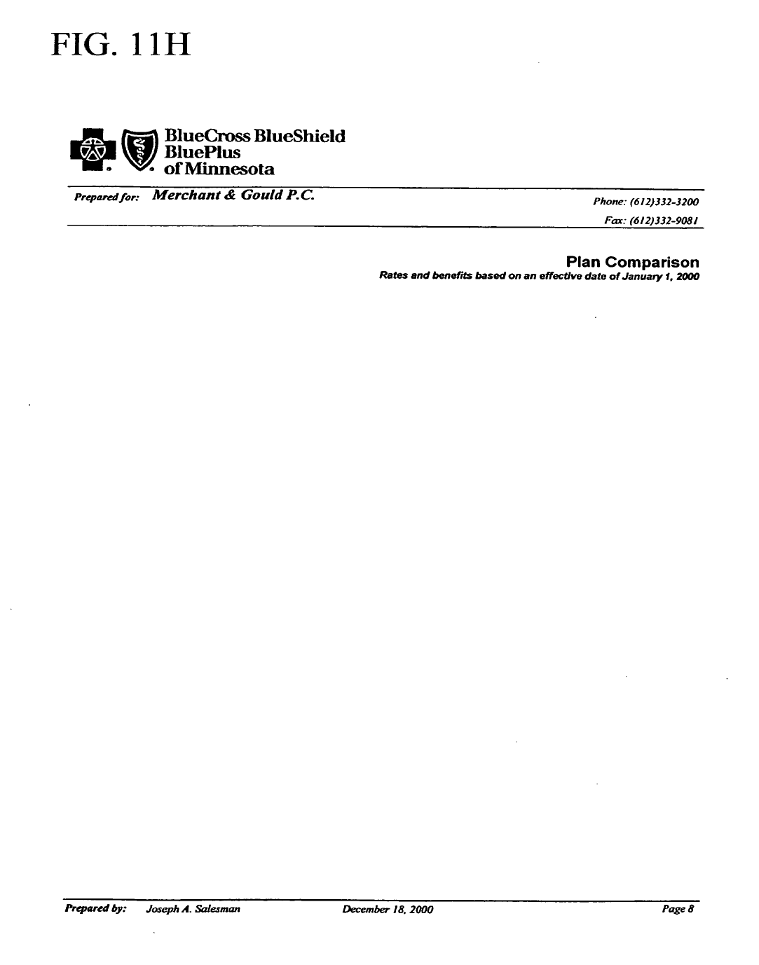

FIG. 11 illustrates an example proposal generated by an insurance configuration and sales computing system according to the present invention. This eight page proposal represents the sales proposal information that is given to a customer based upon all of the user data input into the system as well as the particular plans that have been selected by the prospective customer.

The insurance configuration and sales computing system is supported by three other applications; sales computing system Toolkit, Configuration Plus, and User Administration. The Signature Plus Toolkit allows the configuration model viewed through sales computing system to be updated and changed. It allows the sales organization to: easily manage complex data models for configuration, pricing, and other functionality and customize the look and feel of the entire sales system, from graphics and drop-down lists to color palettes and fonts, using common, open-platform programming languages such as Visual Basic and Java. In addition, these tools allow a user to import data from across the company, customize that data to meet customer needs, and easily update it independent of other company functions or third-party vendors.

The user may also change and update the sales computing system on-line. Help feature to address the sales force's specific questions, ensuring that they can use the full capabilities of the sales system with confidence and link the sales enterprise to other enterprise applications.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be defined by the claims appended hereto.

What is claimed is:

1-61. (canceled)

62. A method comprising:
receiving at a server customer information and a request for an insurance plan from a client communicatively coupled to the server via the network;
performing, by the server, a search of an insurance plan database storing a plurality of insurance plans for the requested insurance plan, wherein the insurance plan database is communicatively coupled to the server;
generating, by the server, a customized insurance proposal including the requested insurance plan, an estimated cost associated with the requested insurance plan, and a portion of the customer information; and
transmitting, by the server, the customized insurance proposal to the client via the network.

63. The method of claim 1, wherein a plurality of insurance plans are requested, the method further comprising:
performing, by the server, a search of the insurance plan database for the requested plurality of insurance plans;
providing, by the server, the requested plurality of insurance plans to the client;
receiving, by the server, a selection of one of the requested plurality of insurance plans from the client; and
generating, by the server, a customized insurance proposal including the selected insurance plan, an estimated cost associated with the requested insurance plan, and a portion of the customer information.

64. The method of claim 63, further comprising:
generating, by the server, a comparison of the plurality of insurance plans; and
providing, by the server, the comparison to the client.

65. The method of claim 62, wherein the customized insurance plan further comprises at least one of an insurance application form, a benefit chart, and insurance plan provider information.

66. The method of claim 62, further comprising:
providing, by the server, the customized insurance plan proposal in electronic form to a customer associated with the customer information.

67. The method of claim 62, further comprising:
determining, by the server, the estimated cost based on at least one of the customer information and information stored in the insurance plan database.

68. The method of claim 62, wherein performing the search further comprises:
determining, by the server, whether an insurance plan included in the plurality of insurance plans is available to a customer based upon the customer information, wherein the customer is associated with the customer information.

69. The method of claim 68, wherein the insurance plan is not available to the customer, the method further comprising:
providing, by the server, a message to the client indicating that the insurance plan is not available to the customer.

70. The method of claim 69, wherein the message further includes one or more conditions the customer must meet in order qualify for the insurance plan.

71. The method of claim 62, wherein the plurality of insurance plans include at least one of a health insurance plan, a dental insurance plan, a life insurance plan, and a disability insurance plan.

72. The method of claim 62, further comprising:
receiving, by the server, a request to enroll in the insurance plan; and
responsively to the received request, performing, by the server, at least one of:
providing additional information regarding the insurance plan to the client;
providing a request for additional customer information to the client; and
transmitting the received request to an insurance company associated with the insurance plan.

73. A server comprising:
a processor configured to receive customer information and a request for an insurance plan from a client via a communication port communicatively coupled to the network, perform a search of an insurance plan database storing a plurality of insurance plans for the requested insurance plan, wherein the insurance plan database is communicatively coupled to the server, and generate a customized insurance proposal including the requested insurance plan, an estimated cost associated with the requested insurance plan, and a portion of the customer information, and provide the customized insurance proposal to the client; and
the communication port enabling the server to communicate with the client via the network.

74. A system comprising:
a client communicatively coupled to a server via the network and configured to transmit customer information and a request for an insurance plan to the server and receive a customized insurance proposal from a server;
an insurance plan database communicatively coupled to the server and configured to store a plurality of insurance plans; and
the server configured to perform search of the insurance plan database for the requested insurance plan, generate the customized insurance proposal, wherein the customized insurance proposal includes the requested insurance plan, an estimated cost associated with the requested insurance plan, and a portion of the customer information, and transmit the customized insurance proposal to the client.
